(19) United States
(12) Patent Application Publication
(10) Pub. No.: US 2009/0086982 A1
(43) Pub. Date: Apr. 2, 2009

(54) CROSSTALK CANCELLATION FOR CLOSELY SPACED SPEAKERS

(75) Inventors: Prajakt V. Kulkarni, San Diego, CA (US); Pei Xiang, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/864,552

(22) Filed: Sep. 28, 2007

(51) Int. Cl. H04R 5/00

(52) U.S. Cl. 381/1

(57) ABSTRACT

A technique for canceling acoustic crosstalk is provided including a pre-processing filter and a crosstalk cancellation device. The pre-processing filter may be configured to obtain first and second channel signals and compensate or adjust the first and/or second channel signals for anticipated subsequent stage distortion by the crosstalk cancellation device. The crosstalk cancellation device maybe configured to receive the compensated first and second channel signals from the pre-processing filter. The crosstalk cancellation device then modifies the first channel signal to cancel anticipated acoustic crosstalk from the second channel signal, and modifies the second channel signal to cancel acoustic crosstalk from the first channel signal. The modified first channel signal is then transmitted over a first speaker and the modified second channel signal is transmitted over a second speaker. The first and second speakers may be closely spaced, yet provide a widened stereo image of the first and second channel signals.

### BACKGROUND

1. Field of the Invention

Various features pertain to crosstalk cancellation of closely spaced speakers to achieve improved stereo sound quality.

2. Description of Related Art

Stereophonic sound, commonly called stereo, reproduces a sound using two or more independent audio channels. Typically, a symmetrical configuration of loudspeakers is used to create a pleasant and natural impression of sound heard from various directions, as in natural hearing. However, the use of multiple speakers or audio channels may create acoustic crosstalk. Acoustic crosstalk refers to the leakage or “bleeding” of sound from one sound wave into another sound wave.

Such acoustic crosstalk is particularly problematic where closely spaced speakers are employed. For instance, while listening to stereo signals using closely spaced speakers, the width of stereo image heard by the user is limited to the distance between the two stereo speakers. Stereo imaging refers to the recreation of sound waves that simulate position differences in the original sound source. When using stereo headphones, the sound is delivered directly into a user's ear, thereby avoiding the possibility of acoustic crosstalk. However, when using closely spaced speakers (such as on a mobile phone), the sound emitted by each speaker propagates through the air and is received by both the left and right ears, resulting in acoustic crosstalk. In order to widen the stereo image, it is desirable to completely eliminate or greatly reduce this acoustic crosstalk.

Consequently, a method is needed that reduces or eliminates the effects of acoustic crosstalk for closely spaced speakers.

### BRIEF SUMMARY

A technique for canceling acoustic crosstalk is provided including a pre-processing filter and a crosstalk cancellation device. The pre-processing filter may be configured to obtain first and second channel signals and compensate or adjust the first and/or second channel signals for anticipated subsequent stage distortion by the crosstalk cancellation device. The crosstalk cancellation device maybe configured to receive the compensated first and second channel signals from the pre-processing filter. The crosstalk cancellation device then modifies the first channel signal to cancel anticipated acoustic crosstalk from the second channel signal, and modifies the second channel signal to cancel acoustic crosstalk from the first channel signal. The modified first channel signal is then transmitted over a first speaker and the modified second channel signal is transmitted over a second speaker.

One implementation provides a device comprising a pre-processing filter and a crosstalk cancellation device. The pre-processing filter may be configured to (a) obtain a first and second channel signals that comprise a stereo signal, (b) compensate for anticipated subsequent stage distortion to the first channel signal, and/or (c) compensate for anticipated subsequent stage distortion to the second channel signal. The crosstalk cancellation device may be configured to (a) obtain the compensated first channel signal, (b) modify the first channel signal to cancel anticipated acoustic crosstalk from the second channel signal, (c) obtain the compensated second channel signal, and/or (d) modify the second channel signal to cancel acoustic crosstalk from the first channel signal.

The pre-processing filter may include (a) a plurality of band-pass filters to divide the first channel signal into a plurality of frequency bands; and/or (b) at least one signal attenuators to attenuate a selected frequency band, thereby compensating for anticipated unwanted gain in that frequency band due to the crosstalk cancellation device.

The crosstalk cancellation device may be optimized for acoustic crosstalk cancellation at a particular distance. The crosstalk cancellation device may also be tuned for an approximate one sample delay between a direct path acoustic signal and a crosstalk path acoustic signal.

The combination of the pre-processing device and crosstalk cancellation device may provide a substantially flat frequency response over a frequency range of interest. The substantially flat frequency response may be characterized by the modified first channel signal having a substantially linear magnitude response over the frequency range of interest. The substantially flat frequency response may be characterized by the modified first channel signal having a substantially linear phase delay over the frequency range of interest.

A first speaker may be coupled to the crosstalk cancellation device to transmit the modified first channel signal. Similarly, a second speaker coupled to the crosstalk cancellation device to transmit the modified second channel signal. The first and second speakers may be spaced ten (10) centimeters apart or less.

Similarly, a method for crosstalk cancellation of a stereo signal is also provided comprising: (a) configuring a crosstalk cancellation device to modify a first channel signal of the stereo signal to cancel acoustic crosstalk from a second channel signal of the stereo signal; (b) ascertaining a frequency response characteristic for the crosstalk cancellation device for a range of desired frequencies; (c) providing the first and second channel signals to a pre-processing filter prior to reaching the subsequent stage crosstalk cancellation device; (d) configuring the pre-processing stage filter to compensate for anticipated distortion to the first channel signal caused by the subsequent stage crosstalk cancellation device; and/or (e) providing the compensated first channel signal from the pre-processing filter to the crosstalk cancellation device. The method may also involve (f) configuring the crosstalk cancellation device to modify the second channel signal to cancel acoustic crosstalk from the first channel signal; (g) configuring the pre-processing stage filter to compensate for distortions to the second channel signal caused by the crosstalk cancellation device; (h) providing the compensated second channel signal from the pre-processing filter to the crosstalk cancellation device; (i) transmitting the modified first channel signal from the crosstalk cancellation device via a first speaker; and/or (j) transmitting the modified second channel signal from the crosstalk cancellation device via a second speaker.

The modified first and second channel signals may have a substantially linear magnitude response over a frequency range of interest. The pre-processing filter may add linear phase delay to the left and right channel signals. The crosstalk cancellation device may be pre-optimized for acoustic crosstalk cancellation at an intended listener at a particular distance. In one example, the crosstalk cancellation device is tuned for an approximate one sample delay between a direct path acoustic signal and a crosstalk path acoustic signal.

Consequently, a stereo signal crosstalk canceller is provided comprising: (a) means for modifying a first channel signal at a crosstalk cancellation device to cancel acoustic crosstalk from a second channel signal; (b) means for ascertaining a frequency response characteristic for the crosstalk cancellation device for a range of desired frequencies; (c) means for providing the first and second channel signals to a pre-processing filter prior to reaching the subsequent stage crosstalk cancellation device; (d) means for compensating, at the pre-processing stage filter, for anticipated distortion to the first channel signal caused by the subsequent stage crosstalk cancellation device; (e) means for providing the compensated first channel signal from the pre-processing filter to the crosstalk cancellation device; (f) means for modifying the second channel signal at the crosstalk cancellation device to cancel acoustic crosstalk from the first channel signal; (g) means for compensating, at the pre-processing stage filter, for distortions to the second channel signal caused by the crosstalk cancellation device; (h) means for providing the compensated second channel signal from the pre-processing filter to the crosstalk cancellation device; (i) means for acoustically transmitting the modified first channel signal from the crosstalk cancellation device; and/or (j) means for acoustically transmitting the modified second channel signal from the crosstalk cancellation device.

A computer-readable medium is also provided comprising instructions for performing acoustic crosstalk cancellation of stereo signals, which when executed by a processor causes the processor to: (a) obtain a first and second channel signals, (b) compensate for anticipated subsequent stage distortion to the first channel signal; (c) modify the first channel signal to cancel anticipated acoustic crosstalk from the second channel signal; (d) compensate for anticipated subsequent stage distortion to the second channel signal; (e) modify the second channel signal to cancel acoustic crosstalk from the first channel signal; (f) transmit the modified first channel signal; and/or (g) transmit the modified second channel signal through a separate channel from the modified first channel signal.

Similarly, a processor is provided including a processing circuit configured to (a) obtain a first and second channel signals, (b) compensate for anticipated subsequent stage distortion to the first channel signal, (c) modify the first channel signal to cancel anticipated acoustic crosstalk from the second channel signal, (d) compensate for anticipated subsequent stage distortion to the second channel signal, (e) modify the second channel signal to cancel acoustic crosstalk from the first channel signal, (f) transmit the modified first channel signal, and/or (g) transmit the modified second channel signal through a separate channel from the modified first channel signal.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 is a block diagram illustrating a crosstalk cancellation using a pre-processing filter and crosstalk cancellation network to minimize the crosstalk effect and achieve a wider stereo image for a listener.

FIG. 2 illustrates one example of a device that may be configured to deliver a widened stereo image via closely spaced left and right speakers.

FIG. 3 is a block diagram illustrating one example of a pre-processing linear phase filter and a crosstalk cancellation network tuned to the geometrical setup illustrated in FIG. 2.

FIG. 4 is an example of a frequency response plot illustrating the frequency response of the crosstalk cancellation network illustrated in FIG. 3.

FIG. 5 is an example of a frequency response plot illustrating the frequency response of the pre-processor FIR filter illustrated in FIG. 3.

FIG. 6 is an example of a frequency response plot illustrating the frequency response of the combination of the pre-processor FIR filter and crosstalk cancellation network (direct path) illustrated in FIG. 3.

FIG. 7 also illustrates the linear phase response of the combination of the pre-processor FIR filter and crosstalk cancellation network (direct path) illustrated in FIG. 3.

FIG. 8 is a block diagram illustrating one example of a pre-processing filter configured to compensate for frequency attenuation and/or amplification of frequency bands by a subsequent crosstalk cancellation network.

FIG. 9 illustrates a method for processing stereo signals to reduce or eliminate acoustic crosstalk while avoiding distortion across a desired frequency range.

FIG. 10 illustrates a method operational on a pre-processing filter stage to compensate for anticipated distortion of stereo signals at a subsequent stage crosstalk cancellation device.

FIG. 11 illustrates a method operational on a crosstalk cancellation device to cancel anticipated acoustic crosstalk from closely spaced speakers.

### DETAILED DESCRIPTION OF EMBODIMENTS OF THE INVENTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

In one or more examples and/or configurations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above are also be included within the scope of computer-readable media.

Moreover, a storage medium may represent one or more devices for storing data, including read-only memory (ROM), random access memory (RAM), magnetic disk storage mediums, optical storage mediums, flash memory devices and/or other machine readable mediums for storing information.

Furthermore, embodiments may be implemented by hardware, software, firmware, middleware, microcode, or any combination thereof. When implemented in software, firmware, middleware or microcode, the program code or code segments to perform the necessary tasks may be stored in a computer-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

One feature provides crosstalk cancellation by employing a simplified version of the well-known Atal-Schroder crosstalk cancellation technique combined with a frequency compensation linear phase finite impulse response (FIR) filter to achieve relatively flat response at the output of crosstalk cancellation.

In 1966, Atal and Schroeder used physical reasoning to determine how a crosstalk canceller comprising only two loudspeakers placed symmetrically in front of a single listener could work. (See U.S. Pat. No. 3,236,949). The objective of a crosstalk canceller is to reproduce a desired signal at a single target position while canceling out the sound perfectly at all remaining target positions. The Atal-Schroeder crosstalk cancellation technique involves the addition, to the right-hand loudspeaker signal, of an out-of-phase version of the left channel signal anticipated to reach the right ear of the intended listener via crosstalk, and the addition, to the left-hand loudspeaker signal, of an out-of-phase version of the right-hand channel signal expected to reach the left ear of the listener via crosstalk.

The crosstalk canceller proposed by Atal-Schroeder focused on reproducing a phantom sound source anywhere within 180 degrees in front plane of the user. This technique is known to add unnatural coloration to the sound, especially when the speakers are spaced very close to each other. Other crosstalk cancellation techniques, such as head-related transfer function (HRTF), also called anatomical transfer function (ATF), are complex and computationally expensive to implement in real-world applications.

According to one implementation, a wider stereo expansion image may be achieved by simplifying the Atal-Schroeder crosstalk cancellation network and adding a pre-processing FIR filter. Adding the pre-processing FIR filter significantly reduces the tone coloration added by traditional crosstalk cancellation network. The pre-processor filter may be a linear phase filter that does not add additional phase distortion to the signal, thereby preserving relative delays between direct and crosstalk signal.

Many handheld devices such as mobile handsets (e.g., mobile phones, etc.) are equipped with stereo speakers to playback stereo multimedia content (e.g., voice, audio, music, etc.). However, due to a small form factor of many handheld devices, the stereo speakers are typically spaced very close to each other. For example, spacing of two (2) to six (6) centimeters (cm) is quite common in commercially available handheld devices. Since the speakers in such handheld devices are small in size, they often exhibit poor low frequency response and speaker distortion of low frequencies.

Stereo playback using very closely spaced speakers (e.g., two to six centimeters) pose serious limitations in delivering a good stereo effect even for good stereo content. This is mainly due to the high crosstalk signal received by opposite ear.

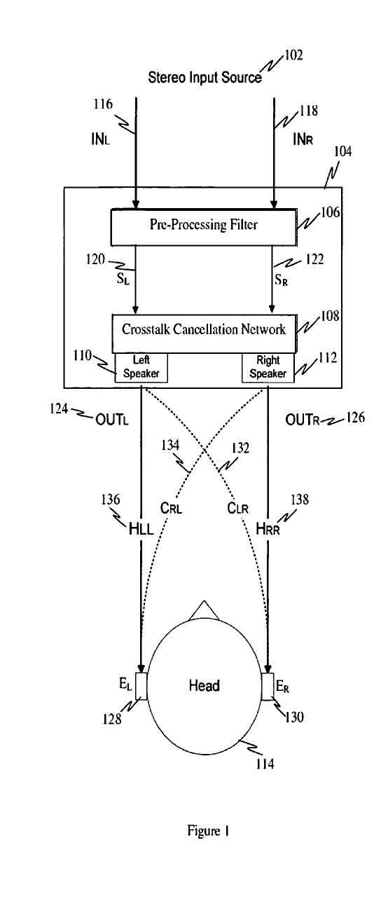

FIG. 1 is a block diagram illustrating a crosstalk cancellation using a pre-processing filter and crosstalk cancellation network to minimize the crosstalk effect and achieve a wider stereo image for a listener. In this example, a stereo input source 102 may provide a stereo signal to a device 104 having a pre-processing filter 106 a crosstalk cancellation network 108 and a plurality of speakers 110 and 112 that provide a corresponding acoustic sound signal to a listener 114. The stereo signal from the stereo input source 102 may include a left channel signal IN_{L} 116 and a right channel signal IN_{R} 118 that may simulate the position differences in an original sound source. For example, the original sound source may include multiple musical instruments on a stage, with the sound from each instrument arriving at a listener's right or left ear depending on the location of said instrument. The composition of the left and right channel signals 116 and 118 simulate the relative position differences in the original sound source.

The pre-processing filter 106 may be a finite impulse response (FIR) filter which is configured to attenuate the lower band and higher band frequencies to compensate for frequency boost added by direct and crosstalk filters of the crosstalk cancellation network 108. The pre-processing filter 106 minimizes coloration and clipping issues. Applying the pre-processing filter in cascade with direct or crosstalk filter ensures that the combined frequency response is relatively flat over large range of frequencies. The pre-processing filter 106 outputs a left channel signal S_{L} 120 and right channel signal S_{R} 122 to the crosstalk cancellation network 108.

The crosstalk cancellation network 108 then modifies each channel signal to compensate for the anticipated or expected crosstalk at the listener's corresponding ear and transmits the audio signal through the corresponding left speaker 110 and right speaker 112. That is, a left output channel signal OUT_{L} 124 propagates from the left speaker 110 and is intended for the listener's left ear 128, but as the left output channel signal OUT_{L} 124 propagates through the air, it also reaches the listener's right ear 130 as crosstalk C_{LR} 132. Similarly, a right output channel signal OUT_{R} 126 propagates from the right speaker 112 and is intended for the listener's right ear 130, but as the right output channel signal OUT_{R} 126 propagates through the air, it also reaches the listener's left ear 128 as crosstalk C_{RL} 134. Consequently, the channel signals OUT_{L} 124 and OUT_{R} 126 from the left and right speakers 110 and 112, respectively, do not directly reach the left and right ears, respectively, but undergo a transformation while the sound is transmitted through the air. The left output channel signal OUT_{L} 124 is transformed according to the left path acoustic transfer function H_{LL} and the right-speaker-to-left-ear crosstalk signal C_{RL} 134. Similarly, the right output channel signal OUT_{R} 126 is transformed according to the right path acoustic transfer function H_{RR} and the left-speaker-to-right-ear crosstalk signal C_{LR} 132.

The resulting output [E_{L}, E_{R}] that listener 114 hears can be described by:

$$[ \begin{matrix}{E}_{L} \\ {E}_{R}\end{matrix} ] = [ \begin{matrix}{H}_{LL} & {C}_{RL} \\ {C}_{LR} & {H}_{RR}\end{matrix} ] \cdot [ \begin{matrix}{OUT}_{L} \\ {OUt}_{R}\end{matrix} ] \qquad ( Equation 1 )$$

The purpose of the crosstalk cancellation network 108 is to eliminate this acoustic transfer function H in Equation 1, so that user gets the original stereo signals IN_{L} 116 and IN_{R} 118 at the left ear 128 and the right ear 130, respectively. The output signals OUT_{L} 124 and OUT_{R} 126 may be represented as the stereo input signals IN_{L} 116 and IN_{R} 118 modified by the crosstalk cancellation network 108 function Y, such that

$$[ \begin{matrix}{E}_{L} \\ {E}_{R}\end{matrix} ] = [ \begin{matrix}{H}_{LL} & {C}_{RL} \\ {C}_{LR} & {H}_{RR}\end{matrix} ] \cdot [ \begin{matrix}{Y}_{LL} & {Y}_{RL} \\ {Y}_{LR} & {Y}_{RR}\end{matrix} ] \cdot [ \begin{matrix}{IN}_{L} \\ {IN}_{R}\end{matrix} ] \qquad ( Equation 2 )$$

Consequently, good crosstalk cancellation means that the network canceller function Y cancels the acoustic transfer function H, such that:

$$Y = {H}^{- 1} \\ where \\ Y = [ \begin{matrix}{Y}_{LL} & {Y}_{RL} \\ {Y}_{LR} & {Y}_{RR}\end{matrix} ] \\ and \\ H = [ \begin{matrix}{H}_{LL} & {C}_{RL} \\ {C}_{LR} & {H}_{RR}\end{matrix} ] . \qquad ( Equation 3 )$$

A typical Schroeder crosstalk cancellation network employs the knowledge of the angle at which the stereo speakers are located and the perceived angle where the phantom source is to be positioned. However, in implementing stereo sound on handheld devices, expanding the stereo image is of interest, not necessarily positioning a sound to a particular angle. Consequently, the crosstalk cancellation network 108 may implement a simplified version of the Schroeder crosstalk cancellation network where the signal paths related to phantom source locations are removed from the crosstalk network.

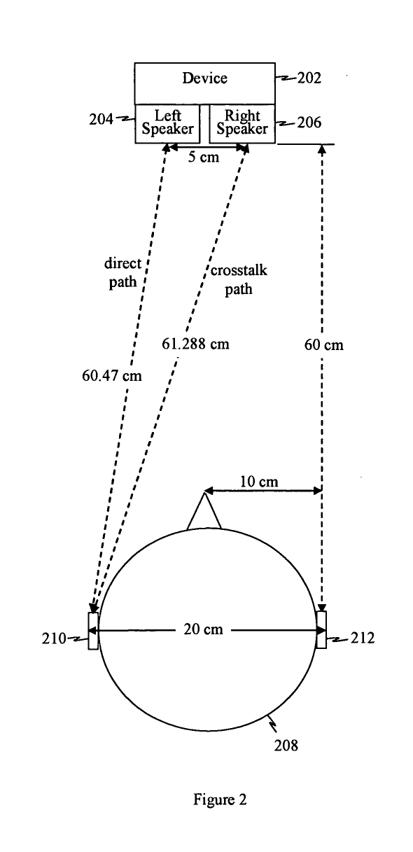

FIG. 2 illustrates one example of a device 202 that may be configured to deliver a widened stereo image via closely spaced left and right speakers 204 and 206. In this example, the left and right speakers are separated approximately 5 centimeters (cm) and the distance to the intended listener 208 is assumed to be approximately 60 cm. A typical user 208 may have a head approximately 20 cm in diameter. These distances may approximate a mobile phone having dual speakers and held by the listener 208 in front of his/her head. The distance between left ear 210 and left speaker 204 (direct path) is approximately 60.47 cm. whereas the distance between right speaker 206 and left ear (crosstalk path) is approximately 61.288 cm. At the speed of sound (of 340 meters/second) this means that the crosstalk signal from right speaker 206 arrives 0.0242 milliseconds later than the direct signal from the left speaker 204. For a sampling rate of 44.1 kHz for the stereo signals transmitted through the speakers 204 and 206, this translates to approximately a one (1) sample delay between the direct path signal and the crosstalk path signal as perceived by the listener 208 at each ear.

To achieve good crosstalk cancellation results, the crosstalk cancellation network may be tuned according to the crosstalk delay and gain parameters. The delay value is derived based on the geometrical setup of the speakers 204 and 206 and the intended listener's head 208 and converting the time delay into delay in samples at a sampling rate (e.g., 44.1 kHz).

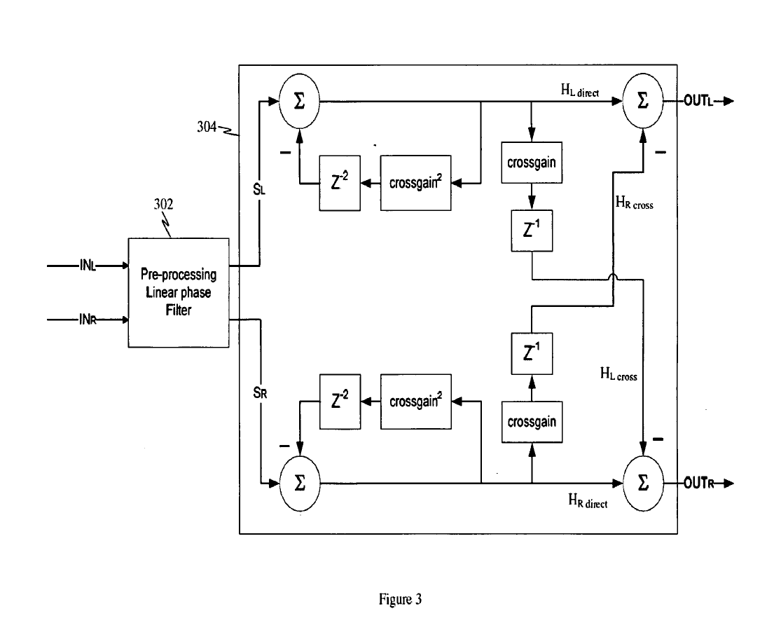

FIG. 3 is a block diagram illustrating one example of a pre-processing linear phase filter 302 and a crosstalk cancellation network 304 tuned to the geometrical setup illustrated in FIG. 2. In this example, a stereo input signal including a left channel signal IN_{L} and a right channel signal IN_{R} are processed by the pre-processing linear phase filter 302 and the crosstalk cancellation network 304 to produce a corresponding left channel output signal OUT_{L} and right channel output signal OUT_{R}.

For the one sample delay resulting from the configuration of FIG. 2, and assuming symmetry between the left and right speakers, the network cancellation transfer function Y (illustrated in Equation 2) of the crosstalk cancellation network 304 may be represented as:

$$\begin{matrix}{Y}_{LL} = {Y}_{RR} = \frac{1}{1 - {crossgain}^{2} \cdot {z}^{- 2}} & ( Equation 4 ) \\ {Y}_{LR} = {Y}_{RL} = \frac{- crossgain \cdot {z}^{- 1}}{1 - {crossgain}^{2} \cdot {z}^{- 2}} & ( Equation 5 )\end{matrix}$$

where crossgain<1.0, is the crosstalk attenuation. For closely spaced speakers, crosstalk attenuation is very close to 1.0. However due to sound absorption by the human head, the crossgain can be tuned to a smaller number.

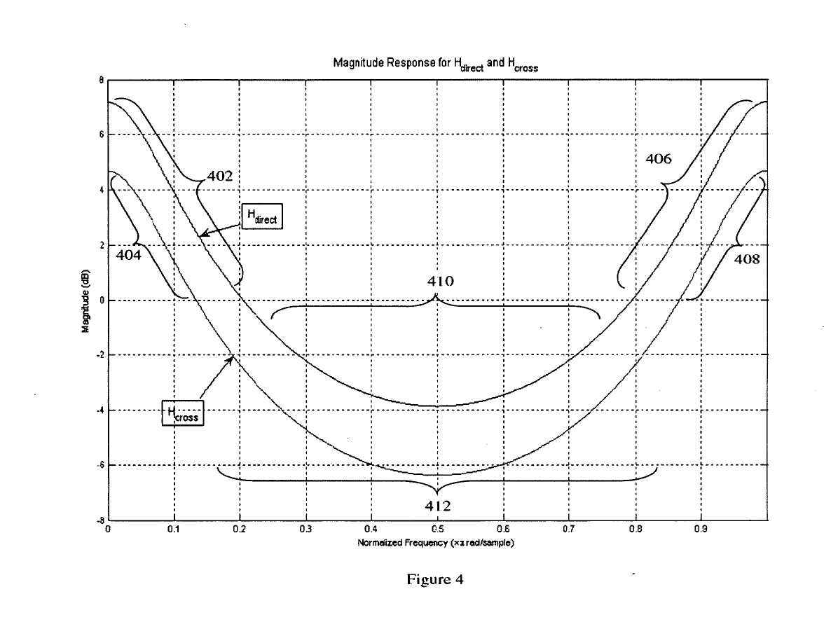

FIG. 4 is an example of a frequency response plot illustrating the frequency response of the crosstalk cancellation network 304 illustrated in FIG. 3. This plot illustrates the direct response H_{direct} and the crosstalk response H_{cross} of the crosstalk cancellation network 304. It is noted that both the direct filter path (producing response H_{direct}) and crosstalk filter path (producing the response H_{cross}) of the crosstalk cancellation network 304 add significant gain to bass frequencies 402 and 404 and treble frequencies 406 and 408 while slightly attenuating the mid-range frequencies 410 and 412. Additional boost and attenuation is cancelled when the direct and crosstalk sound signals arrive at the listener's ears. However, for crosstalk cancellation to work correctly it is necessary that the listener be located exactly at the sweet spot as described by FIG. 2 (i.e., approximately centered between the speakers and at approximately the expected distance to the speakers). If the listener moves a little bit toward left or right, the crosstalk signal delays change and significant coloration (frequency skewing) is heard by the user, resulting in unnatural reproduction of the input signal. In fixed point arithmetic, where the pulse-code modulation (PCM) samples are represented using fixed bit-width numbers, the additional gain may also sometimes lead to digital saturation or clipping.

To minimize these coloration and clipping issues, the current method uses a pre-processing FIR filter 302 (FIG. 3) which attenuates the lower band frequencies (bass) and higher band frequencies (treble) to compensate for frequency boost added by the direct and crosstalk filters of crosstalk network 304.

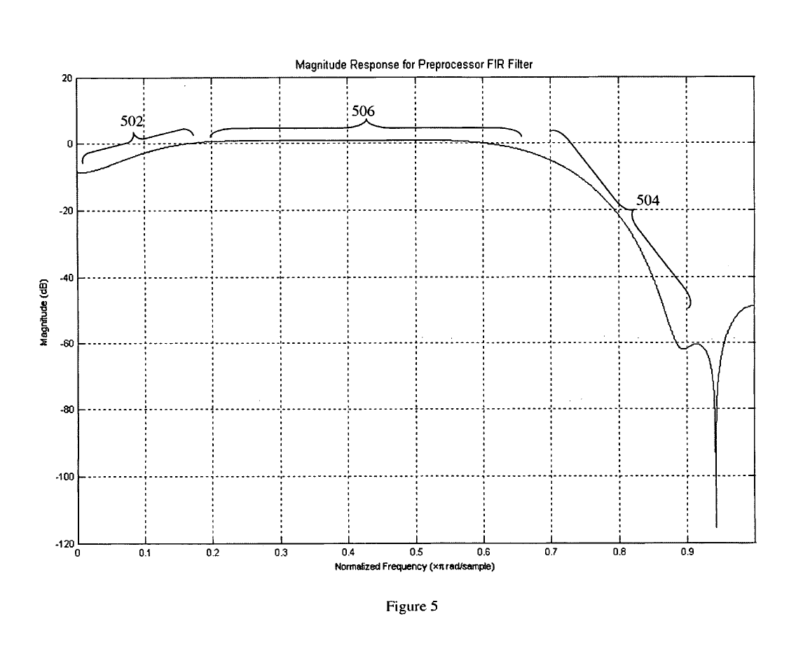

FIG. 5 is an example of a frequency response plot illustrating the frequency response of the pre-processor FIR filter 302 illustrated in FIG. 3. This plot illustrates how the pre-processor filter 302 may be configured to attenuate the lower band (bass) frequencies 502 and the upper band (treble) frequencies 504 while keeping the mid-range frequencies 506 response approximately flat (i.e., keeping gain close to 0 db).

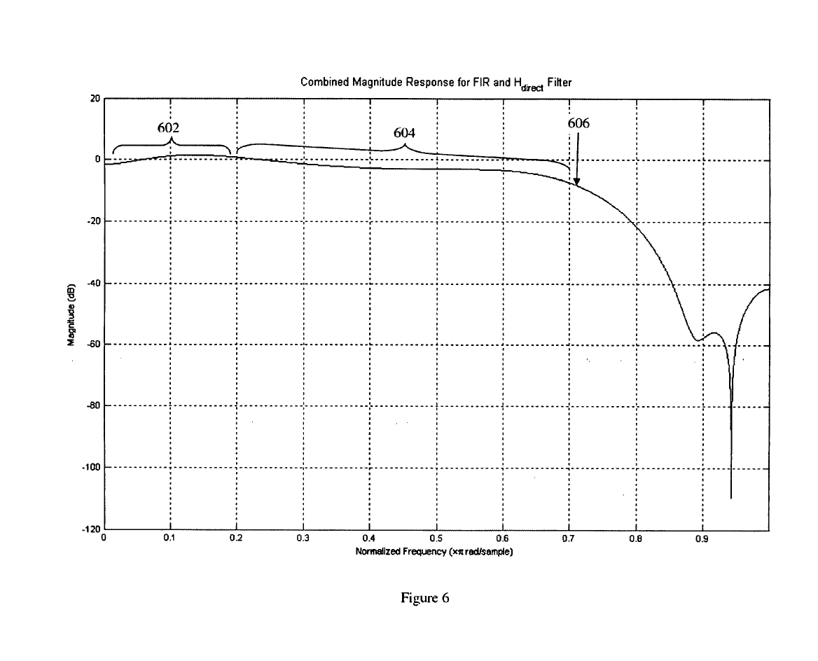

FIG. 6 is an example of a frequency response plot illustrating the frequency response of the combination of the pre-processor FIR filter 302 and crosstalk cancellation network 304 (direct path) illustrated in FIG. 3. This frequency response plot may illustrate the combination of the frequencies responses shown in FIGS. 4 and 5. Note that while this plot illustrates the frequency versus magnitude response for the direct path (H_{direct}) for the crosstalk cancellation network 304, the response is very similar for the crosstalk path (H_{cross}). Applying the pre-processing filter 302 in cascade (series) with the crosstalk cancellation network 304 ensures that the combined frequency response (via the direct path and crosstalk path of the network 304) is relatively flat over large range of frequencies, including the lower band (bass) frequencies 602 and mid-range band frequencies 604. There is a sharp roll-off 606 at frequencies beyond approximately 2.25 radians (e.g., beyond 16 kHz for 44.1 kHz sampling rate) in the combined frequency response. However these high frequencies are poorly reproduced by the small speakers used in mobile or handheld devices. Hence the attenuated high frequencies should not significantly affect the sound quality of stereo reproduction.

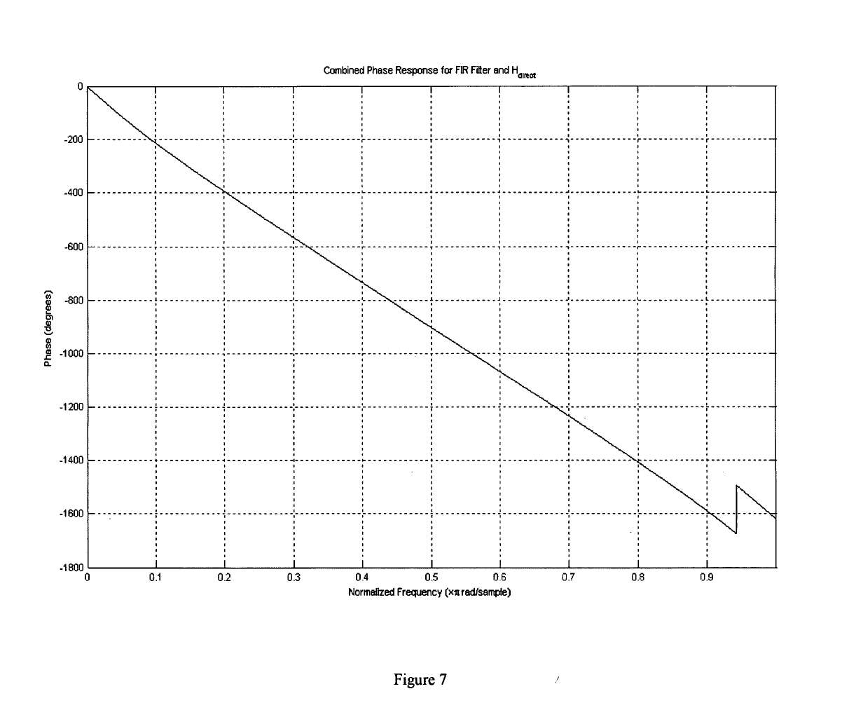

FIG. 7 also illustrates the linear phase response of the combination of the pre-processor FIR filter 302 and crosstalk cancellation network 304 (direct path) illustrated in FIG. 3. Note that while this plot illustrates the frequency versus phase response for the direct path (H_{direct}) for the crosstalk cancellation network 304, the response is very similar for the crosstalk path (H_{cross}).

It should be clearly understood that the signal channel characteristics illustrated in FIGS. 4, 5, 6, and 7 may be illustrative of the characteristics of each separate channel signal (e.g., first and second channel signals, left and right channel signals, etc.) comprising a stereo signal. Consequently, the signal characteristics may be substantially the same for each channel signal of the stereo signal.

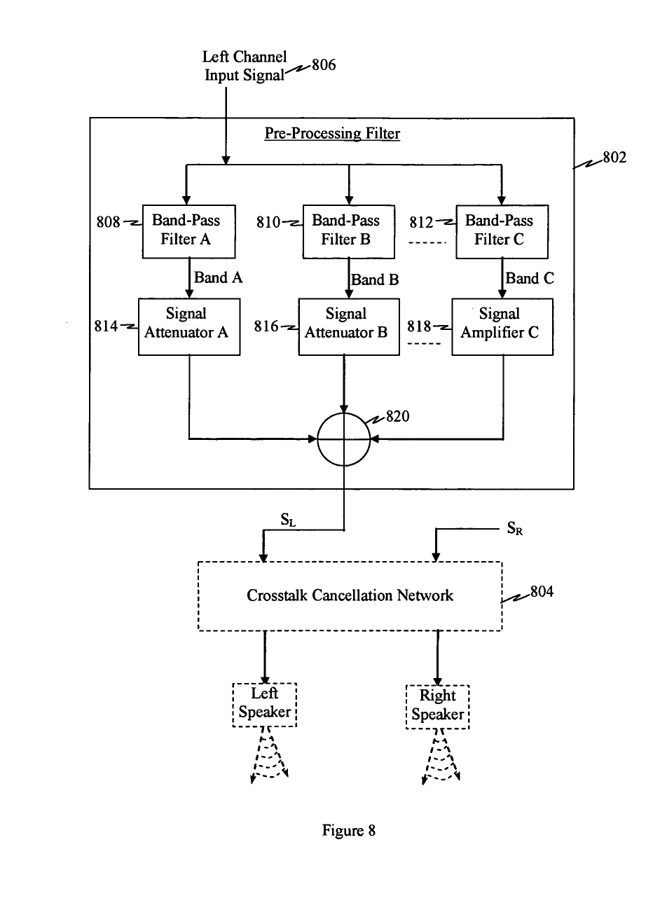

FIG. 8 is a block diagram illustrating one example of a pre-processing filter 802 configured to compensate for frequency attenuation and/or amplification of frequency bands by a subsequent crosstalk cancellation network 804. In this example, the pre-processing filter 802 receives a left channel signal 806 for a stereo input signal. In various implementations, the pre-processing filter 802 may include one or more filters, attenuators, and/or amplifier components and/or circuits. For example, depending on the performance of the subsequent stage crosstalk cancellation network 804 (which may attenuate some frequency bands while amplifying other frequency bands), the pre-processing filter 802 may include one or more band-pass filters 808, 810, and 812 that splits the left stereo input signal 806 for independent attenuation (by corresponding signal attenuators 814 and 816) and/or amplification (by corresponding signal amplifier 818). In this manner, the pre-processing filter 802 may compensate for the frequency response of the crosstalk cancellation network 804 that may attenuate some frequency bands and/or amplify other frequency bands. For example, referring to the frequency versus magnitude response of FIG. 5 for a pre-processing filter, the pre-processing filter 802 may attenuate certain frequency bands 502 and 504 while amplifying or keeping the gain close to zero (0) db for other frequency bands 506. The frequency bands are combined 820 prior to sending the signal S_{L} to the crosstalk cancellation network 804.

Note that the configuration of the pre-processing filter 802 depends on the frequency response of the crosstalk cancellation network 804 at various bands of interest. Consequently, the band-pass filters 808, 810, and 812, signal attenuators 814 and 816 and/or signal amplifiers 818 may be designed to compensate for a corresponding frequency response characteristic of the crosstalk cancellation network 804 over a frequency range of interest. In this example for the left stereo input signal 806, the pre-processing filter 802 may compensate for the frequency response of the left direct path (H_{L direct} in FIG. 3) and right crosstalk path (H_{R cross} in FIG. 3) of the crosstalk cancellation network 804.

While the pre-processing filter 802 shows a left stereo input signal 806 being processed, a similar filter may be employed for a right stereo input signal. Such filter may compensate for the frequency response of the right direct path (H_{R direct} in FIG. 3) and left crosstalk path (H_{L cross} in FIG. 3) of the crosstalk cancellation network 804 and provide an output signal S_{R} to the crosstalk cancellation network 804.

In some implementations, the crosstalk cancellation network 804 may operate like the crosstalk cancellation network 304 illustrated in FIG. 3. In some implementations, the pre-processing filter 802 and crosstalk cancellation network 804 may also be configured to provide a substantially linear phase response (as illustrated in FIG. 7 for instance).

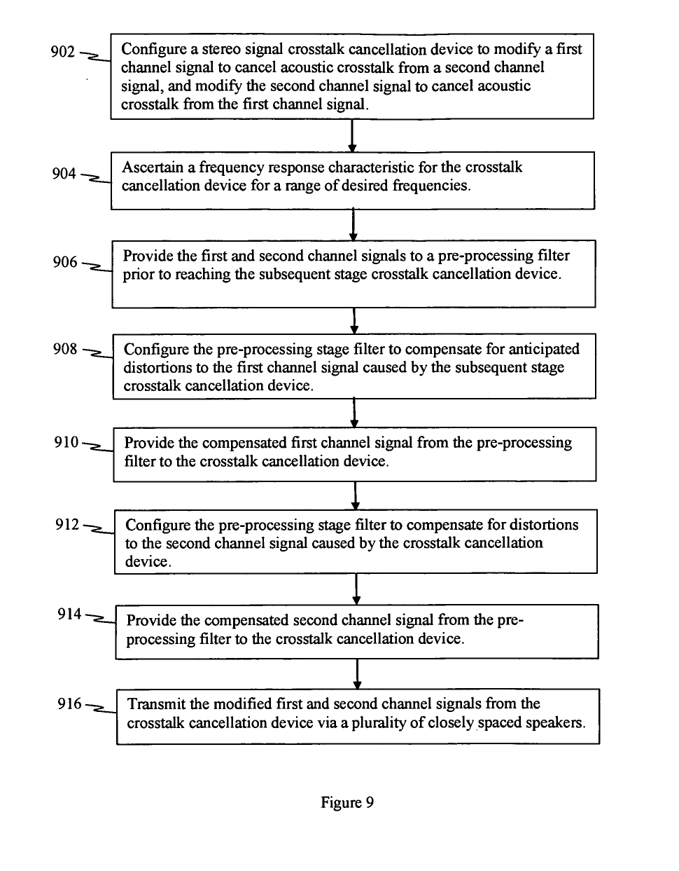

FIG. 9 illustrates a method for processing stereo signals to reduce or eliminate acoustic crosstalk while avoiding distortion across a desired frequency range. This method may be implemented in a mobile device having a pre-processing filter and subsequent stage crosstalk cancellation network as described in FIGS. 1-8. As used herein, a stereo signal includes a first (right) channel signal and a second (left) channel signal. A stereo signal crosstalk cancellation device may be configured to modify a first channel signal (e.g., right channel of a stereo signal) to cancel acoustic crosstalk from a second channel signal (e.g., left channel of the stereo signal), and modify the second channel signal to cancel acoustic crosstalk from the first channel signal 902. A frequency response characteristic may be ascertained for the crosstalk cancellation device for a range of desired frequencies 904. For example, the frequency versus magnitude or phase response of the crosstalk cancellation device may be ascertained for a desired range of frequencies.

The first and second channel signals may be provided to a pre-processing filter prior to reaching the subsequent stage crosstalk cancellation device 906. The pre-processing stage filter may be configured to compensate for anticipated distortions to the first channel signal caused by the subsequent crosstalk cancellation device 908. For example, the pre-processing stage filter may compensate for unwanted amplification and/or attenuation of certain frequency bands by the crosstalk cancellation device. The compensated first channel signal is then provided from the pre-processing filter to the crosstalk cancellation device 910.

Similarly, the pre-processing stage filter may be configured to compensate for distortions to the second channel signal caused by the crosstalk cancellation device 912. The compensated second channel signal is then provided from the pre-processing filter to the crosstalk cancellation device 914.

The modified first and second channel signals are transmitted from the crosstalk cancellation device via a plurality of closely spaced speakers 916.

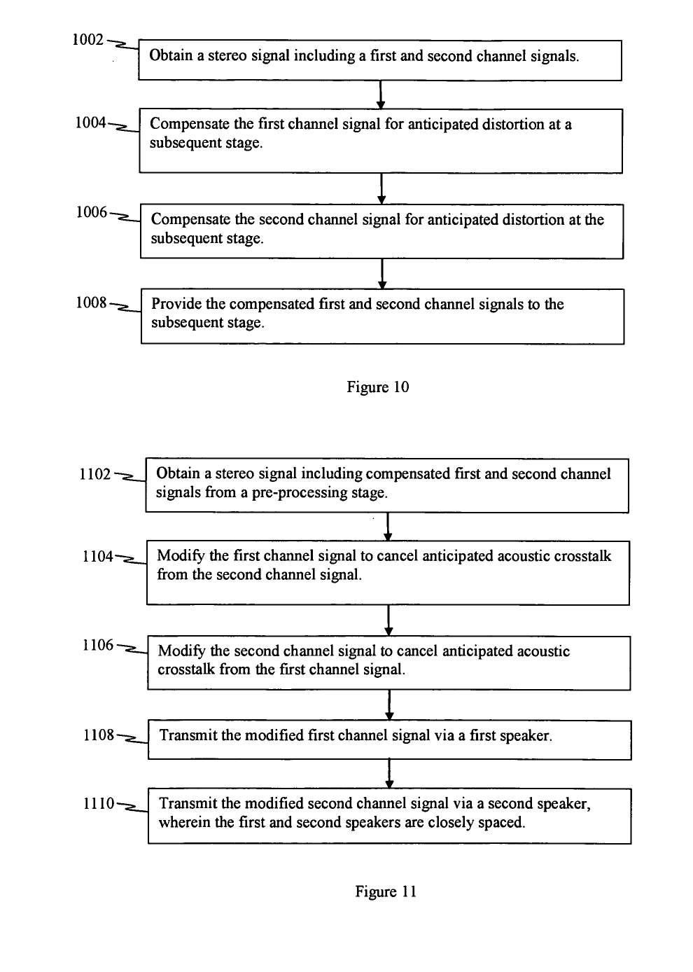

FIG. 10 illustrates a method operational on a pre-processing filter stage to compensate for anticipated distortion of stereo signals at a subsequent stage crosstalk cancellation device. A stereo signal including a first channel signal and a second channel signal is obtained 1002. The first channel signal is compensated for anticipated distortion at a subsequent stage 1004. For instance, the first channel signal may have its magnitude for some frequency bands attenuated and/or amplified while leaving its magnitude at other frequency bands substantially unchanged. Additionally, the phase of the first channel signal (or specific frequency bands of the first channel signal) may or may not be compensated to account for anticipated phase shifts in the subsequent stage. Similarly, the second channel signal may also be compensated for anticipated distortion at the subsequent stage 1006. The compensated first and second channel signals are then provided to the subsequent stage 1008.

FIG. 11 illustrates a method operational on a crosstalk cancellation device to cancel anticipated acoustic crosstalk from closely spaced speakers. Compensated first and second channel signals, comprising a stereo signal, are obtained from a pre-processing stage 1102. The first channel signal is modified to cancel anticipated acoustic crosstalk from the second channel signal 1104. The second channel signal is also modified to cancel anticipated acoustic crosstalk from the first channel signal 1106. The modified first channel signal may be transmitted via a first speaker 1108 and the modified second channel signal may be transmitted via a second speaker 1110, where the first and second speakers may be closely spaced (e.g., less than 10 cm apart).

One or more of the components, steps, and/or functions illustrated in FIGS. 1, 2, 3, 4, 5, 6, 7, 8, 9, 10 and/or 11 may be rearranged and/or combined into a single component, step, or function or embodied in several components, steps, or functions. Additional elements, components, steps, and/or functions may also be added without departing from the invention. The apparatus, devices, and/or components illustrated in FIGS. 1, 2, 3 and/or 8 may be configured to perform one or more of the methods, features, or steps described in FIGS. 4, 5, 6, 7, 9, 10 and/or 11. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features described herein can be implemented in different systems. For example, the pre-processing filter and/or crosstalk cancellation network may be implemented in a single circuit or module, on separate circuits or modules, executed by one or more processors, executed by computer-readable instructions incorporated in a machine-readable or computer-readable medium, and/or embodied in a handheld device, mobile computer, and/or mobile phone.

It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A device comprising:
a pre-processing filter configured to
obtain a first and second channel signals that comprise a stereo signal, and
compensate for anticipated subsequent stage distortion to the first channel signal; and
a crosstalk cancellation device coupled to the pre-processing filter and configured to
obtain the compensated first channel signal, and
modify the first channel signal to cancel anticipated acoustic crosstalk from the second channel signal.

2. The device of claim 1, wherein the pre-processing filter is further configured to
compensate for anticipated subsequent stage distortion to the second channel signal; and
the crosstalk cancellation device is further configured to
obtain the compensated second channel signal, and
modify the second channel signal to cancel acoustic crosstalk from the first channel signal.

3. The device of claim 2, further comprising:
a first speaker coupled to the crosstalk cancellation device to transmit the modified first channel signal; and
a second speaker coupled to the crosstalk cancellation device to transmit the modified second channel signal.

4. The device of claim 3, wherein the first and second speakers are spaced ten (10) centimeters apart or less.

5. The device of claim 1, wherein the combination of the pre-processing device and crosstalk cancellation device provide a substantially flat frequency response over a frequency range of interest.

6. The device of claim 5, wherein the substantially flat frequency response is characterized by the modified first channel signal having a substantially flat magnitude response over the frequency range of interest.

7. The device of claim 5, wherein the substantially flat frequency response is characterized by the modified first channel signal having a substantially linear phase delay over the frequency range of interest.

8. The device of claim 1, wherein the pre-processing filter includes
a plurality of band-pass filters to divide the first channel signal into a plurality of frequency bands; and
at least one signal attenuators to attenuate a selected frequency band, thereby compensating for anticipated unwanted gain in that frequency band due to the crosstalk cancellation device.

9. The device of claim 1, wherein the crosstalk cancellation device is optimized for acoustic crosstalk cancellation at a particular distance.

10. The device of claim 1, wherein the crosstalk cancellation device is tuned for an approximate one sample delay between a direct path acoustic signal and a crosstalk path acoustic signal.

11. A method for crosstalk cancellation of a stereo signal, comprising:
configuring a crosstalk cancellation device to modify a first channel signal of the stereo signal to cancel acoustic crosstalk from a second channel signal of the stereo signal;
ascertaining a frequency response characteristic for the crosstalk cancellation device for a range of desired frequencies;
providing the first and second channel signals to a pre-processing filter prior to reaching the subsequent stage crosstalk cancellation device;
configuring the pre-processing stage filter to compensate for anticipated distortion to the first channel signal caused by the subsequent stage crosstalk cancellation device; and
providing the compensated first channel signal from the pre-processing filter to the crosstalk cancellation device.

12. The method of claim 11, further comprising:
configuring the crosstalk cancellation device to modify the second channel signal to cancel acoustic crosstalk from the first channel signal;
configuring the pre-processing stage filter to compensate for distortions to the second channel signal caused by the crosstalk cancellation device; and
providing the compensated second channel signal from the pre-processing filter to the crosstalk cancellation device.

13. The method of claim 12, further comprising:
transmitting the modified first channel signal from the crosstalk cancellation device via a first speaker; and
transmitting the modified second channel signal from the crosstalk cancellation device via a second speaker.

14. The method of claim 13, wherein the modified first and second channel signals having a substantially linear magnitude response over a frequency range of interest.

15. The method of claim 13, wherein the pre-processing filter adding linear phase delay to the first and second channel signals.

16. The method of claim 11, wherein the crosstalk cancellation device is pre-optimized for acoustic crosstalk cancellation at an intended listener at a particular distance.

17. The method of claim 11, wherein the crosstalk cancellation device is tuned for an approximate one sample delay between a direct path acoustic signal and a crosstalk path acoustic signal.

18. A device comprising:
means for modifying a first channel signal at a crosstalk cancellation device to cancel acoustic crosstalk from a second channel signal;
means for ascertaining a frequency response characteristic for the crosstalk cancellation device for a range of desired frequencies;
means for providing the first and second channel signals to a pre-processing filter prior to reaching the subsequent stage crosstalk cancellation device;
means for compensating, at the pre-processing stage filter, for anticipated distortion to the first channel signal caused by the subsequent stage crosstalk cancellation device; and
means for providing the compensated first channel signal from the pre-processing filter to the crosstalk cancellation device.

19. The device of claim 18, further comprising:
means for modifying the second channel signal at the crosstalk cancellation device to cancel acoustic crosstalk from the first channel signal;
means for compensating, at the pre-processing stage filter, for distortions to the second channel signal caused by the crosstalk cancellation device; and
means for providing the compensated second channel signal from the pre-processing filter to the crosstalk cancellation device.

20. The device of claim 19, further comprising:
means for acoustically transmitting the modified first channel signal from the crosstalk cancellation device; and
means for acoustically transmitting the modified second channel signal from the crosstalk cancellation device.

21. A computer-readable medium comprising instructions for performing acoustic crosstalk cancellation of stereo signals, which when executed by a processor causes the processor to
obtain a first and second channel signals,
compensate for anticipated subsequent stage distortion to the first channel signal; and
modify the first channel signal to cancel anticipated acoustic crosstalk from the second channel signal.

22. The computer-readable medium of claim 21 further comprising instructions to:
compensate for anticipated subsequent stage distortion to the second channel signal;
modify the second channel signal to cancel acoustic crosstalk from the first channel signal;
transmit the modified first channel signal; and
transmit the modified second channel signal through a separate channel from the modified first channel signal.

23. A processor comprising:
a processing circuit configured to
obtain a first and second channel signals,
compensate for anticipated subsequent stage distortion to the first channel signal; and
modify the first channel signal to cancel anticipated acoustic crosstalk from the second channel signal.

24. The processor of claim 23, wherein the processing circuit is further configured to
compensate for anticipated subsequent stage distortion to the second channel signal; and
modify the second channel signal to cancel acoustic crosstalk from the first channel signal.

25. The processor of claim 24, wherein the processing circuit is further configured to
transmit the modified first channel signal; and
transmit the modified second channel signal through a separate channel from the modified first channel signal.
